(19) United States
(12) Patent Application Publication
(10) Pub. No.: US 2005/0071063 A1
(43) Pub. Date: Mar. 31, 2005

(54) Acceleration detecting apparatus and occupant protective system using same

(75) Inventor: Toshiyuki Yamashita, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: MITSUBISHI DENKI KABUSHIKI KAISHA

(21) Appl. No.: 10/898,347

(22) Filed: Jul. 26, 2004

(30) Foreign Application Priority Data
Sep. 30, 2003 (JP) 2003-341034

(51) Int. Cl. B60R 21/32

(52) U.S. Cl. 701/45; 701/70; 180/282

(57) ABSTRACT

An acceleration detecting apparatus and occupant protective system using it are provided which can detect acceleration in a wider range with maintaining the high resolution in detecting low acceleration. The acceleration detecting apparatus includes an acceleration sensor for detecting acceleration; and an acceleration correcting section for obtaining when acceleration outside a range detectable by the acceleration sensor is applied, the acceleration outside the range by calculation. The occupant protective system includes, in addition to the acceleration detecting apparatus, an occupant protective apparatus installed in a vehicle; and a driving unit for driving the occupant protective apparatus in response to the acceleration from the acceleration detecting apparatus.

### BACKGROUND OF THE INVENTION

1. Field of the Invention

The present invention relates to an acceleration-detecting apparatus for detecting acceleration and an occupant protective system using it, and more particularly to a technique for detecting acceleration outside a range detectable by an acceleration sensor.

2. Description of Related Art

An occupant protective system for protecting the occupants from a crash of a vehicle has been known conventionally. In an occupant protective system, when the vehicle experiences an impact (acceleration) because of a frontal collision, for example, an acceleration sensor in an acceleration detecting apparatus contained in an airbag control unit installed in the vehicle, detects the acceleration due to the impact, and outputs an acceleration signal corresponding to the magnitude of the acceleration. The acceleration signal output from the acceleration sensor is converted into digital data by an A/D converter, and supplied to a microcomputer. The microcomputer makes a decision as to whether to expand the airbag according to the received digital data. The decision result is supplied to a driving unit for driving the airbag. In this way, the driving unit drives the airbag and expands it as necessary, thereby being able to protect the occupants of the vehicle.

As a related technique, Relevant Reference 1 discloses a vehicle occupant protective system capable of calculating the deceleration at the vehicle crash without adding any large processing section. The vehicle occupant protective system can calculate the deceleration more accurately because it prevents the acceleration integration from being accumulated in the normal running. The vehicle occupant protective system sets a range from a reference value GL to GH expected in the normal running of the vehicle for a physical quantity calculated from an impact acceleration detection signal generated at the crash of the vehicle.

Relevant Reference 2 discloses a vehicle crash detecting apparatus for supplying a crash signal to a vehicle occupant protective apparatus such as an airbag as a start signal at the crash of the vehicle. The vehicle crash detecting apparatus includes an integrating section for integrating the output of an acceleration sensor when its output exceeds a calculation start level; a crash detecting section for outputting a crash signal in response to a fact that the integral calculated by the integrating section exceeds a threshold value; a differentiating section for differentiating the output of the acceleration sensor; and a correcting section for correcting a threshold value in response to a differential value calculated by the differentiating section. It can make a responsive, accurate crash decision regardless of the seriousness of the crash.

Relevant Reference 1: Japanese patent application laid-open No. 2002-331903.

Relevant Reference 2: Japanese patent application laid-open No. 2003-89341.

In the configuration in which the acceleration sensor is placed at the front or side of the vehicle, the acceleration sensor undergoes a great impact at the crash. Accordingly, the conventional acceleration detecting apparatus employs a wide range acceleration sensor to detect the great acceleration.

The wide range acceleration sensor, however, presents problems in that it has low resolution for small acceleration frequently occurs in the normal state, and that it is expensive.

### SUMMARY OF THE INVENTION

The present invention is implemented to solve the foregoing problems. It is therefore an object of the present invention to provide an acceleration detecting apparatus and occupant protective system using it capable of detecting a wider range of acceleration with keeping high resolution for small acceleration.

According to one aspect of the present invention, there is provided an acceleration detecting apparatus including: an acceleration sensor for detecting acceleration; and an acceleration correcting section for obtaining, when acceleration outside a range detectable by the acceleration sensor is applied, the acceleration outside the range by calculation.

According to the present invention, when the acceleration outside the range detectable by the acceleration sensor is applied, the acceleration detecting apparatus obtains the acceleration outside the range by calculation. Consequently, it can detect a wide range of acceleration in an estimating manner with maintaining the high resolution for low acceleration, which is the characteristic of a narrow range acceleration sensor. In addition, since the narrow range acceleration sensor is inexpensive, the acceleration detecting apparatus can be configured at low cost.

### BRIEF DESCRIPTION OF THE DRAWINGS

FIG. 1 is a block diagram showing a schematic configuration of an occupant protective system to which an embodiment 1 of the acceleration detecting apparatus in accordance with the present invention is applied;

FIG. 2 is a flowchart illustrating the main processing in general of an acceleration correcting section in the embodiment 1 of the acceleration detecting apparatus in accordance with the present invention;

FIG. 3 is a flowchart illustrating the detail of the inclination calculating processing of FIG. 2;

FIG. 4 is a flowchart illustrating the detail of the acceleration correcting processing in FIG. 2;

FIG. 5 is a diagram illustrating the correcting processing of the acceleration in the embodiment 1 of the acceleration detecting apparatus in accordance with the present invention;

FIG. 6 is a diagram illustrating the correcting processing of the acceleration in an embodiment 2 of the acceleration detecting apparatus in accordance with the present invention;

FIG. 7 is a flowchart illustrating the correcting processing in the acceleration correcting section in an embodiment 3 of the acceleration detecting apparatus in accordance with the present invention;

FIG. 8 is a diagram illustrating the correcting processing in the acceleration correcting section in the embodiment 3 of the acceleration detecting apparatus in accordance with the present invention;

FIG. 9 is a diagram illustrating the correcting processing in the acceleration correcting section in an embodiment 4 of the acceleration detecting apparatus in accordance with the present invention;

FIG. 10 is a flowchart illustrating the processing in general in the acceleration correcting section in an embodiment 5 of the acceleration detecting apparatus in accordance with the present invention;

FIG. 11 is a graph illustrating a correcting function used by the acceleration correcting section in the embodiment 5 of the acceleration detecting apparatus in accordance with the present invention;

FIG. 12 is a graph illustrating correcting processing in the acceleration correcting section in the embodiment 5 of the acceleration detecting apparatus in accordance with the present invention;

FIG. 13 is a flowchart illustrating the processing in general in the acceleration correcting section in an embodiment 6 of the acceleration detecting apparatus in accordance with the present invention;

FIG. 14 is a graph illustrating a correcting function used by the acceleration correcting section in the embodiment 6 of the acceleration detecting apparatus in accordance with the present invention;

FIG. 15 is a graph illustrating correcting processing in the acceleration correcting section in the embodiment 6 of the acceleration detecting apparatus in accordance with the present invention; and

FIG. 16 is a top view showing an example in which the embodiment of the acceleration detecting apparatus in accordance with the present invention is mounted on a vehicle.

### DETAILED DESCRIPTION OF THE PREFERRED EMBODIMENTS

The embodiments in accordance with the present invention will now be described in detail with reference to the accompanying drawings.

### Embodiment 1

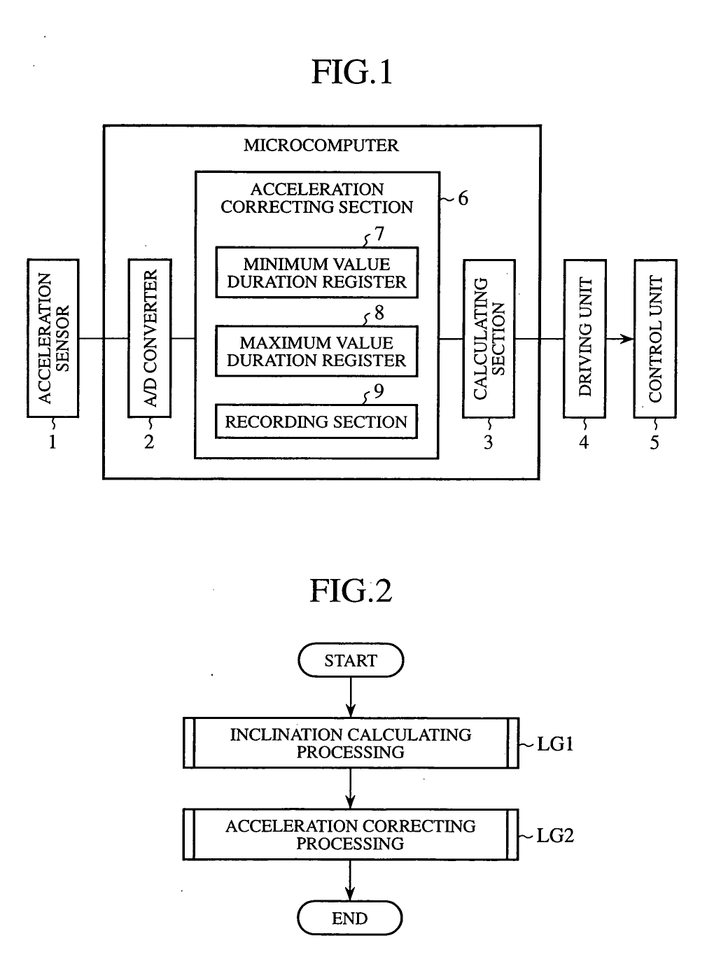

FIG. 1 is a block diagram showing a schematic configuration of an occupant protective system to which an embodiment 1 of the acceleration detecting apparatus in accordance with the present invention is applied. The occupant protective system includes an acceleration sensor 1, an A/D converter 2, an acceleration correcting section 6, a calculating section 3, a driving unit 4 and a control unit 5.

The acceleration sensor 1, A/D converter 2, acceleration correcting section 6, calculating section 3 and driving unit 4 constitute an airbag control unit. The control unit 5 consists of a controlled system such as an airbag and ABS to be controlled by the airbag control unit. The A/D converter 2, calculating section 3 and acceleration correcting section 6 are implemented by a microcomputer.

The acceleration sensor 1 is placed at the front or side of a vehicle not shown, and outputs an acceleration signal with a voltage corresponding to the acceleration (impact) imposed on the vehicle. When the acceleration is greater than the maximum value GH of the acceleration detectable by the acceleration sensor 1, the acceleration sensor 1 outputs its maximum value GH. In contrast, when it is smaller than the minimum value GL of the acceleration detectable by the acceleration sensor 1, it outputs its minimum value GL. The acceleration signal output by the acceleration sensor 1 is supplied to the A/D converter 2.

The A/D converter 2 converts the acceleration signal fed from the acceleration sensor 1 into digital data by sampling the acceleration signal at specified time intervals, that is, sampling time Δt. The digital data produced from the A/D converter 2 is supplied to the acceleration correcting section 6 as an acceleration value.

The acceleration correcting section 6 performs specified processing on the acceleration value fed from the A/D converter 2 as the digital data, thereby correcting the acceleration detected by the acceleration sensor 1. More specifically, the acceleration correcting section 6 carries out restoring processing of the acceleration value in regions in which the acceleration is greater than the maximum value GH or less than the minimum value GL of the acceleration detectable by the acceleration sensor 1 (the details of which will be described later). The acceleration value corrected by the acceleration correcting section 6 is supplied to the calculating section 3.

The calculating section 3 carries out the calculation processing for deciding the need for driving the control unit 5 in response to the acceleration value fed from the acceleration correcting section 6. The calculation processing is performed for each sampled data of the acceleration value. When it decides that the driving of the control unit 5 is necessary as a result of the calculation processing, the calculating section 3 supplies the driving signal to the driving unit 4. The driving unit 4 drives the control unit 5 in response to the driving signal fed from the calculating section 3.

Next, the operation of the embodiment 1 of the acceleration detecting apparatus in accordance with the present invention will be described with focusing attention on the processing of the acceleration correcting section 6.

FIG. 2 is a general flowchart illustrating the main processing of the acceleration correcting section 6. Receiving the acceleration value (digital data) from the acceleration sensor 1 via the A/D converter 2, the acceleration correcting section 6 carries out inclination calculating processing LG1 for calculating the inclination J of the acceleration. The inclination calculating processing corresponds to the inclination calculating section in accordance with the present invention.

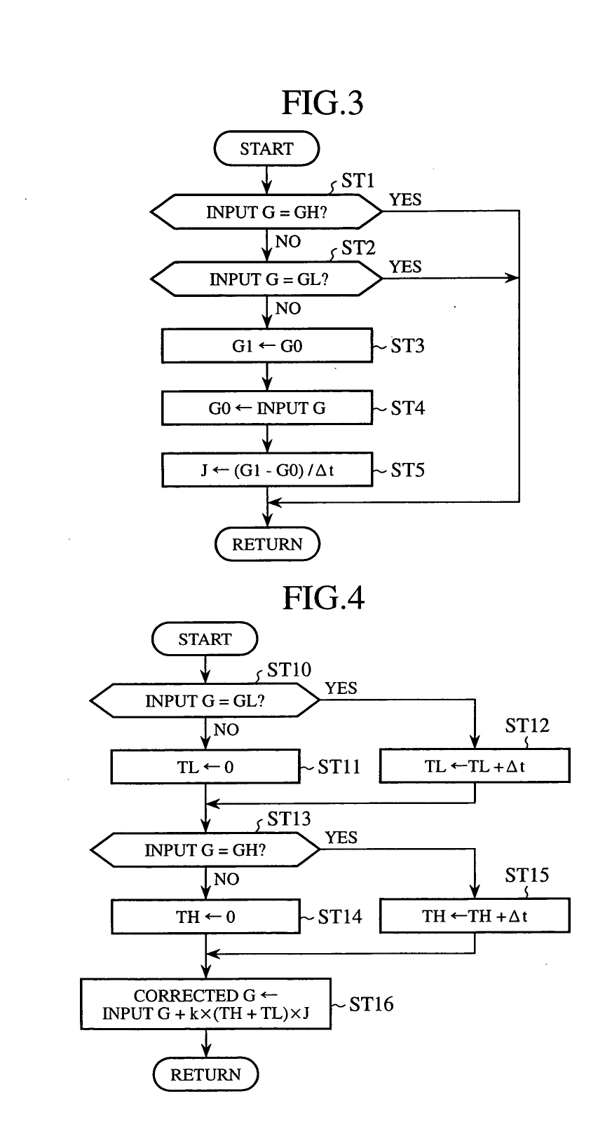

FIG. 3 is a flowchart illustrating the detail of the inclination calculating processing LG1. In the inclination calculating processing LG1, the acceleration correcting section 6 checks first whether the input G, the acceleration value fed from the A/D converter 2 as the digital data, is equal to the maximum value GH of the acceleration detectable by the acceleration sensor 1 (step ST1). If it makes a decision that the input G is equal to the maximum value GH, it recognizes that the acceleration is beyond the range detectable by the acceleration sensor 1 (called “G range” from now on), and returns the sequence to the main processing without calculating the inclination J.

On the other hand, if the acceleration correcting section 6 makes a decision that the input G is not equal to the maximum value GH at step ST1, it checks whether the input G equals the minimum value GL of the acceleration detectable by the acceleration sensor 1 (step ST2). If it makes a decision that the input G is equal to the minimum value GL, it recognizes that the acceleration is less than the Grange, and returns the sequence to the main processing without calculating the inclination J.

If the acceleration correcting section 6 makes a decision that the input G is not equal to the minimum value GL at step ST2, it recognizes that the acceleration is within the G range of the acceleration sensor 1, and carries out the processing for calculating the inclination J of the acceleration (steps ST3-ST5). In the processing, the acceleration correcting section 6 moves the present value G0 of the acceleration stored in a present value register to a previous value register as a previous value G1, first (step ST3). Although both the present value register and previous value register are not shown, they are provided in the acceleration correcting section 6. Subsequently, the acceleration correcting section 6 sets the input G in the present value register as the present value G0 (step ST4). Then, the acceleration correcting section 6 calculates the inclination J of the acceleration according to the following expression (1) (step ST5).
Inclination J=(G1−G0)/Δt (1)

Subsequently, the sequence is returned to the main processing. Incidentally, if the acceleration correcting section 6 makes a decision that the input G is equal to the maximum value GH at step ST1, or equal to the minimum value GL at step ST2, it skips the processing for calculating the inclination J of the acceleration. Accordingly, the acceleration correcting section 6 holds the inclination J of the acceleration calculated immediately before, that is, the inclination J of the acceleration just before the maximum value GH or the minimum value GL of the acceleration detectable by the acceleration sensor 1.

At the next stage, the main processing carries out the acceleration correcting processing LG2 for correcting the acceleration using the inclination J calculated through the inclination calculating processing LG1. The acceleration correcting processing LG2 corresponds to the correcting value calculating section in accordance with the present invention.

FIG. 4 is a flowchart illustrating the details of the acceleration correcting processing LG2. In the acceleration correcting processing LG2, the acceleration correcting section 6 checks whether the input G, the acceleration value fed from the A/D converter 2 as the digital data, is equal to the minimum value GL of the acceleration detectable by the acceleration sensor 1 or not (step ST10). If the acceleration correcting section 6 decides that the input G is not equal to the minimum value GL, it recognizes that the acceleration is within the G range of the acceleration sensor 1, and clears the minimum value duration TL stored in a minimum value duration register 7 to zero (step ST11). The minimum value duration register 7 is provided in the acceleration correcting section 6. Subsequently, the acceleration correcting section 6 advances the sequence to step ST13.

On the other hand, if the acceleration correcting section 6 makes a decision that the input G equals the minimum value GL at step ST10, it recognizes that the acceleration is outside the G range of the acceleration sensor 1. Thus, it adds the sampling time Δt to the minimum value duration TL stored in the minimum value duration register 7 (step ST12), then branches the sequence to step ST13.

The processing from step ST10 to ST12 provides the minimum value duration register 7 with the duration in which the acceleration value is maintained at the minimum value GL, that is, the minimum value duration TL. The minimum value duration register 7 corresponds to part of a measuring section in accordance with the present invention.

Subsequently, the acceleration correcting section 6 checks whether the input G equals the maximum value GH of the acceleration detectable by the acceleration sensor 1 (step ST13). If it makes a decision that the input G is not equal to the maximum value GH, it recognizes that the acceleration is within the G range of the acceleration sensor 1, and clears the maximum value duration TH stored in a maximum value duration register 8 to zero (step ST14). The maximum value duration register 8 is provided in the acceleration correcting section 6. Subsequently, the sequence proceeds to step ST16.

On the other hand, if the acceleration correcting section 6 makes a decision that the input G equals the maximum value GH at step ST13, it) recognizes that the acceleration exceeds the G range of the acceleration sensor 1, and adds the sampling time Δt to the maximum value duration TH stored in the maximum value duration register 8 (step ST15). Subsequently, the sequence branches to step ST16.

The processing from step ST13 to ST15 provides the maximum value duration register 8 with the duration in which the acceleration value is maintained at the maximum value GH, that is, the maximum value duration TH. The maximum value duration register 8 corresponds to another part of the measuring section in accordance with the present invention. In the present specification, the maximum value duration TH and minimum value duration are generically called “duration T”.

Subsequently, the acceleration correcting section 6 corrects the input G according to the following expression (2) using the minimum value duration TL stored in the minimum value duration register 7, the maximum value duration TH stored in the maximum value duration register 8 through the foregoing processing, and the inclination J of the acceleration obtained through the foregoing inclination calculating processing, thereby calculating the corrected G (step ST16).
corrected G=input G+k×(TH+TL)×J (2)
where k is a correcting coefficient.

Subsequently, the sequence returns to the main processing. Then, every time the acceleration value is provided from the acceleration sensor 1, the acceleration correcting section 6 carries out the inclination calculating processing LG1 and acceleration correcting processing LG2 to correct the acceleration value in real time.

Incidentally, as can be understood from the foregoing processing from step ST10 to ST15, one of the minimum value duration TL and maximum value duration TH becomes “0” without exception.

The correcting coefficient k varies depending on the input waveform assumed to be supplied as the acceleration value. When the input waveform is a triangular wave as in the embodiment 1 of the acceleration detecting apparatus, a value “0.5” is used as the correcting coefficient k. This makes it possible to output an acceleration waveform with the corrected G having the same integral (area) as the input waveform of the acceleration.

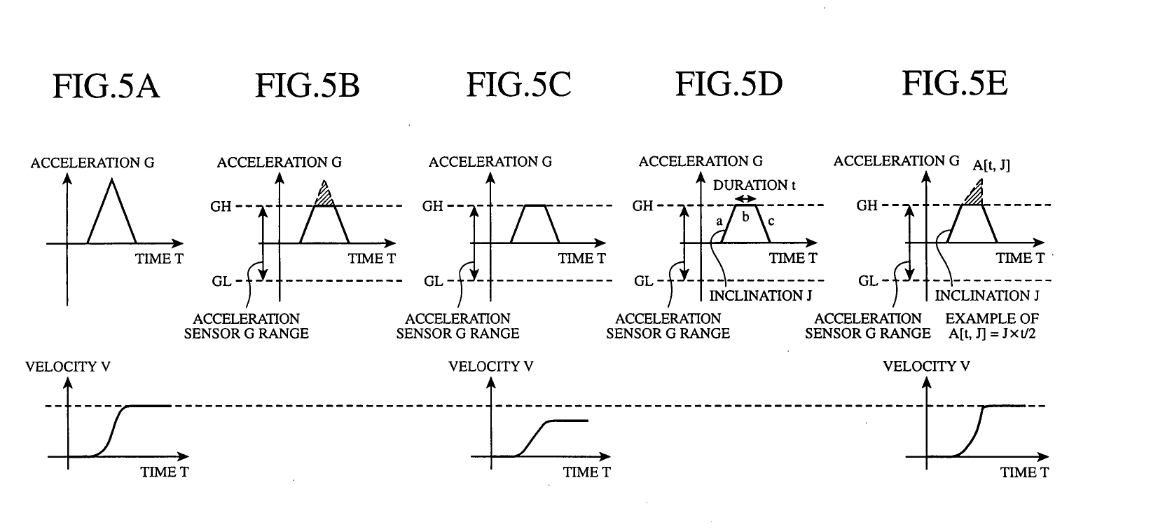

Next, to deepen understanding of the present invention, the functions implemented by the processing illustrated by flowcharts of FIGS. 2-4 will be described with reference to FIG. 5 by way of example in which the input waveform is a triangular wave.

When the acceleration sensor 1 receives the acceleration beyond the G range as illustrated in FIG. 5(A), it cannot detect the acceleration in the region beyond the maximum value GH of the G range (shadowed portion) as illustrated in FIG. 5(B). In this case, the acceleration sensor 1 outputs the maximum value GH in the region beyond the maximum value GH of the G range as illustrated in FIG. 5(C).

The acceleration correcting section 6 carries out the correcting processing of the output of the acceleration sensor 1. First, in the interval a as illustrated in FIG. 5(D), since the output G of the acceleration sensor 1 is within the G range (GL<G<GH), the acceleration correcting section 6 calculates the inclination J.

Subsequently, in the interval b, since the output of the acceleration sensor 1 equals the maximum value GH, the acceleration correcting section 6 carries out the acceleration correction by adding a correcting value A[t, J], which is calculated from the immediately previous inclination J and the duration t of the maximum value GH as illustrated in FIG. 5 (E), to the acceleration in the range undetectable by the acceleration sensor 1.

Subsequently, in the interval c, in which the output G of the acceleration sensor 1 is within the G range (GL<G<GH), the acceleration correcting section 6 calculates the inclination J without carrying out the correction.

Thus correcting the output of the acceleration sensor 1 makes it possible to calculate the area (velocity component) of the acceleration component without a loss as illustrated at the bottom of FIG. 5(E). In contrast with this, when the output of the acceleration sensor 1 is not corrected, the calculation is carried out with losing part of the area (velocity component) of the acceleration component as illustrated at the bottom of FIG. 5(C).

As described above, as for the acceleration outside the detectable range by the acceleration sensor 1, the embodiment 1 of the acceleration detecting apparatus in accordance with the present invention obtains it by the calculation. Consequently, it can detect a wide range of acceleration in an estimating manner with maintaining the characteristic of an arrow range acceleration sensor that it has high resolution for small acceleration. In addition, since the narrow range acceleration sensor is inexpensive, the acceleration detecting apparatus can be configured at low cost.

Although the foregoing embodiment 1 is described by way of example in which the output of the acceleration sensor 1 exceeds the maximum value GH, even in the case where the output of the acceleration sensor 1 is less than the minimum value GL, it is also possible to obtain the acceleration outside the G range by correcting it.

### Embodiment 2

The embodiment 2 of the acceleration detecting apparatus in accordance with the present invention employs 2/π as the correcting coefficient k of expression (2), in the acceleration correcting section of the embodiment r of the acceleration detecting apparatus.

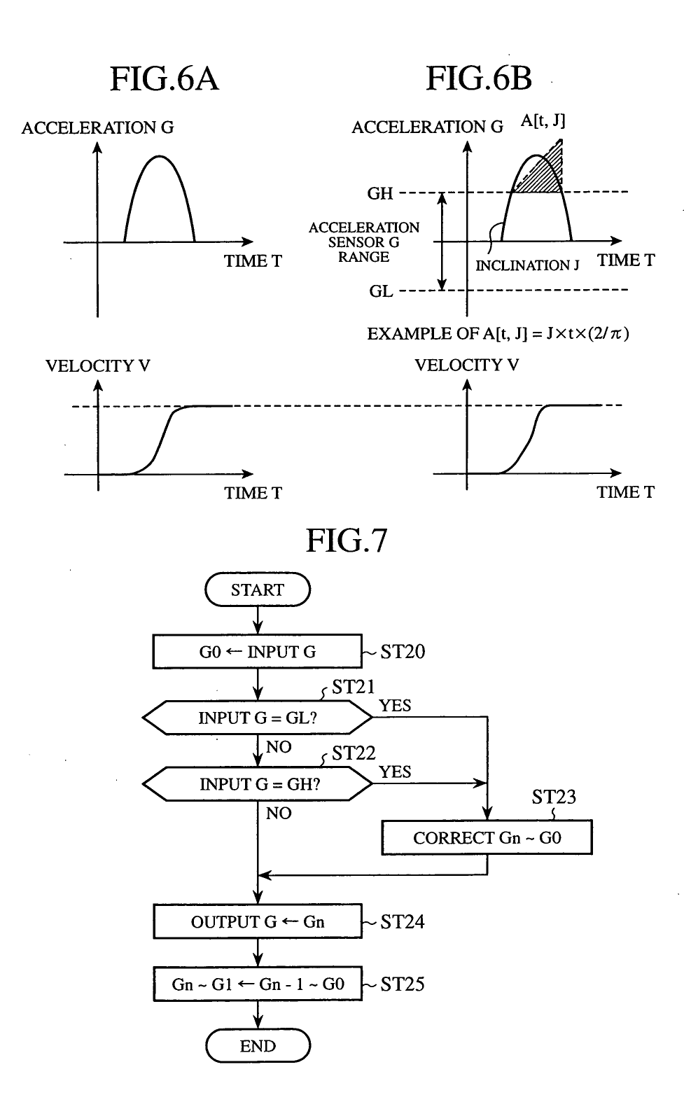

It is very likely that the waveform of the acceleration produced by the acceleration sensor 1 includes a sine wave. When the input waveform is a sine wave, placing the correcting coefficient k at 2/π in expression (2) can output the waveform of the acceleration with the corrected G having the same integral (area) with the input waveform of the acceleration as illustrated in FIG. 6.

Thus setting the correcting coefficient k at an appropriate value in accordance with the characteristics of the waveform input to the acceleration correcting section 6 enables accurate correction.

### Embodiment 3

The foregoing embodiment 1 of the acceleration detecting apparatus is configured such that it corrects the acceleration value from the acceleration sensor 1 in real time. In contrast with this, the present embodiment 3 of the acceleration detecting apparatus is configured such that it temporarily records a plurality of acceleration values in a recording section, and corrects the acceleration values recorded.

The present embodiment 3 of the acceleration detecting apparatus has the same configuration as the embodiment 1 as shown in FIG. 1. Here, the acceleration correcting section 6 includes a recording section 9 for recording (n+1)-acceleration values Gn-G0. The acceleration value Gn is the oldest acceleration value, and the acceleration value G0 is the newest acceleration value.

FIG. 7 is a flowchart illustrating the correcting processing in the acceleration correcting section 6 of the embodiment 3 of the acceleration detecting apparatus.

In the correcting processing, the acceleration correcting section 6 stores the input G, the acceleration value fed from the A/D converter 2 as the digital data, in the recording section as the newest acceleration value G0 (step ST20). Subsequently, the acceleration correcting section 6 checks whether the input G is equal to the minimum value GL of the acceleration detectable by the acceleration sensor 1 or not (step ST21). If a decision is made that the input G equals the minimum value GL, the sequence branches to step ST23.

If the acceleration correcting section 6 makes a decision that the input G is not equal to the minimum value GL at step ST21, it checks whether the input G is equal to the maximum value GH of the acceleration detectable by the acceleration sensor 1 or not (step ST22). If a decision is made that the input G equals the maximum value GH, the sequence branches to step ST23.

If the acceleration correcting section 6 makes a decision that the input G is not equal to the maximum value GH at step ST22, the oldest acceleration value Gn is supplied to the calculating section 3 as the output G (step ST24). Subsequently, the acceleration correcting section 6 stores the plurality of acceleration values Gn-1-G0 in the recording section as the acceleration values Gn-G1 (step ST25).

At step ST23, the acceleration correcting section 6 carries out the correcting processing of the acceleration values Gn-G0 according to the pre-calculated maximum value duration TH or the minimum value duration TL (duration T), and the inclination J of the acceleration. Subsequently, the sequence branches to step ST24.

When the input G is between the minimum value GL and the maximum value GH, the processing is carried out through the steps ST20→ST21→ST22→ST24→ST25 successively without correcting, so that nth previous acceleration value Gn is output. When the input G becomes equal to the minimum value GL or the maximum value GH, the acceleration correcting section 6 carries out the correction, and outputs the corrected nth previous acceleration value Gn.

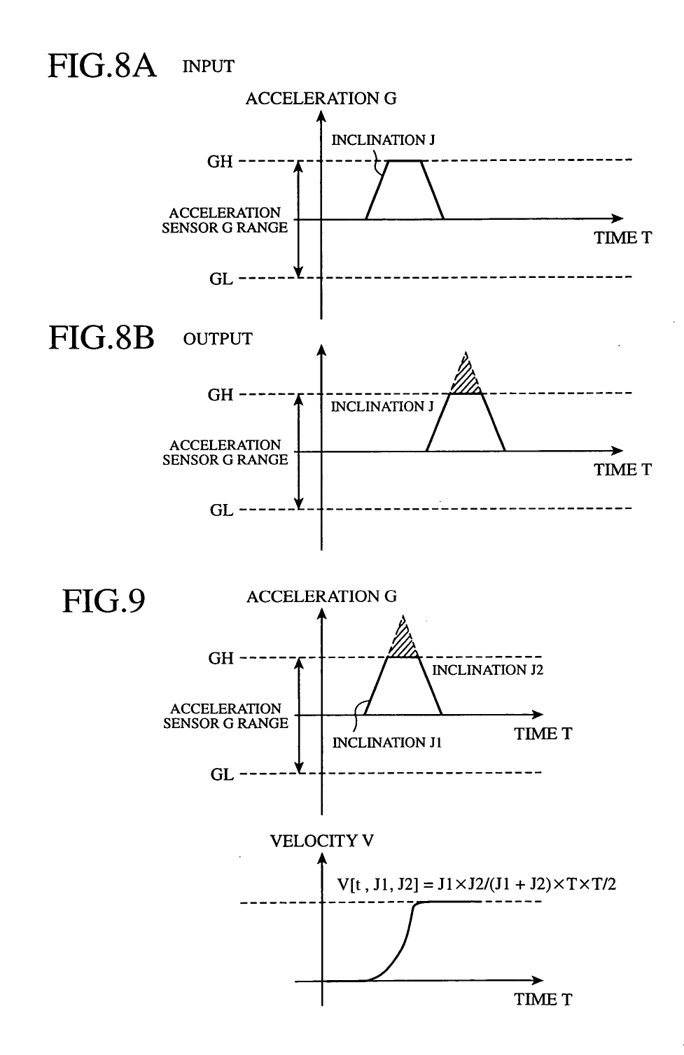

FIG. 8 is a diagram illustrating the correcting processing in the acceleration correcting section 6 of the embodiment 3 of the acceleration detecting apparatus: FIG. 8(A) illustrates the input to the acceleration correcting section 6; and FIG. 8(B) illustrates the output from the acceleration correcting section 6. According to the embodiment 3 of the acceleration detecting apparatus, when a triangular wave is input, the acceleration correcting section 6 can perform the correction of a waveform similar to the input waveform, thereby being able to correct the input waveform without impairing the characteristics of the input waveform.

Incidentally, the embodiment 3 of the acceleration detecting apparatus performs the correction according to the waveform similar to the input waveform supposed. For example, when the input waveform is assumed to be a sine wave, the correction is carried out based on the sine wave.

### Embodiment 4

The embodiment 4 of the acceleration detecting apparatus in accordance with the present invention carries out the correction according to the inclination J1 of the acceleration immediately before the maximum value GH or the minimum value GL of the acceleration detectable by the acceleration sensor 1 (corresponding to the first inclination in accordance with the present invention), the inclination J2 immediately after returning from the maximum value or the minimum value of the acceleration (corresponding to the second inclination in accordance with the present invention), and the maximum value duration TH or the minimum value duration TL.

FIG. 9 is a diagram illustrating the correcting processing by the acceleration correcting section 6 of the present embodiment 4 of the acceleration detecting apparatus in accordance with the present invention. The acceleration correcting section 6 carries out the correction by adding a correcting value V[t, J1, J2]=J1×J2/(J1+J2)×T×T/2 corresponding to the shaded portion of FIG. 9 and serving as a correcting function to the acceleration in the range undetectable by the acceleration sensor 1. Incidentally, using a correcting function corresponding to the supposed input waveform enables more accurate correction.

### Embodiment 5

The present embodiment 5 of the acceleration detecting apparatus is configured such that it carries out the correction using not only the immediately previous inclination J of the acceleration and the maximum value duration TH or the minimum value duration TL, but also the immediately previous frequency characteristic F.

The configuration of the present embodiment 5 of the acceleration detecting apparatus is the same as that of the embodiment 1 as shown in FIG. 1.

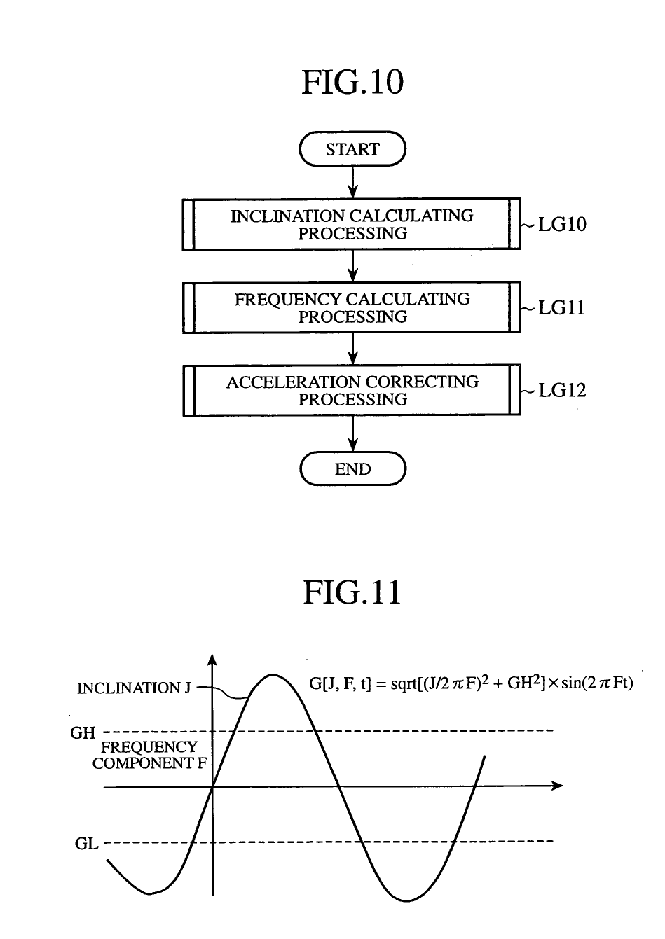

FIG. 10 is a flowchart schematically illustrating the processing of the acceleration correcting section 6. Receiving the acceleration value (digital data) from the acceleration sensor 1 via the A/D converter 2, the acceleration correcting section 6 carries out inclination calculating processing LG10 for calculating the inclination J of the acceleration. The inclination calculating processing LG10 is the same as the inclination calculating processing LG1 in the embodiment 1, and corresponds to the inclination calculating section in accordance with the present invention.

Subsequently, the acceleration correcting section 6 performs frequency calculating processing LG11, which corresponds to the frequency calculating section in accordance with the present invention. In the frequency calculating processing LG11, the acceleration correcting section 6 obtains the frequency component F of the acceleration immediately before the maximum value GH or the minimum value GL of the acceleration detectable by the acceleration sensor 1. As for the frequency component F, the acceleration correcting section 6 can obtain it by performing a fast Fourier transform (FFT) of the acceleration value in a fixed interval immediately before the maximum value GH or the minimum value GL.

Subsequently, the acceleration correcting section 6 carries out the acceleration correcting processing LG12, which corresponds to the correcting value calculating section in accordance with the present invention. In the acceleration correcting processing LG12, the acceleration correcting section 6 calculates a sine wave component from the inclination J obtained in the inclination calculating processing LG10 and the frequency component F obtained in the frequency calculating processing LG11, and carries out the correction by adding the calculated sine wave component to the output of the acceleration sensor 1.

FIG. 11 is a graph illustrating an example of the correcting function used by the acceleration correcting section 6. Assuming that the input waveform is a sine wave, the acceleration correcting section 6 can calculate the waveform from the frequency component F of the acceleration immediately before the maximum value GH or minimum value GL of the acceleration detectable by the acceleration sensor 1, and the inclination J of the acceleration immediately before the maximum value GH or minimum value GL by the following expression (3).
G[J, F, t]=sqrt[(J/2πF)²+GH²]sin(2πFt) (3)

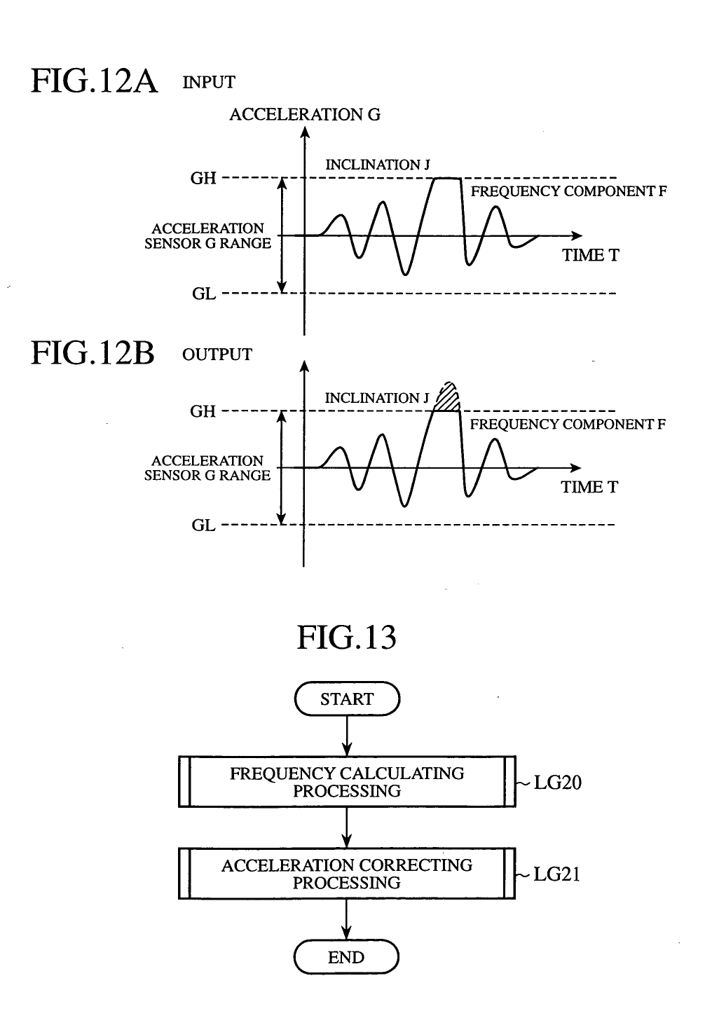

The correction based on such a correcting function enables the input G as illustrated in FIG. 12(A) to be corrected as illustrated by the shadowed portion in FIG. 12(B), when the input G takes the maximum value GH or minimum value GL of the acceleration.

Since the correcting function is composed of the immediately previous inclination J of the acceleration and the immediately previous frequency component F in the present embodiment 5 of the acceleration detecting apparatus, it can correct the acceleration in real time.

### Embodiment 6

The present embodiment 6 of the acceleration detecting apparatus in accordance with the present invention is configured such that it carries out the correction using the immediately previous frequency characteristic F instead of the immediately previous inclination J of the acceleration in the foregoing embodiment 3.

The configuration of the present embodiment 6 of the acceleration detecting apparatus is the same as that of the embodiment 1 as shown in FIG. 1.

FIG. 13 is a flowchart schematically illustrating the processing of the acceleration correcting section 6. Receiving the acceleration value (digital data) from the acceleration sensor 1 via the A/D converter 2, the acceleration correcting section 6 carries out frequency calculating processing LG20 for obtaining the frequency component F of the acceleration immediately before the maximum value GH or minimum value GL of the acceleration detectable by the acceleration sensor 1. The frequency calculating processing LG20 is the same as the frequency calculating processing LG11 of the embodiment 5, and corresponds to the frequency calculating section in accordance with the present invention.

Subsequently, the acceleration correcting section 6 carries out the acceleration correcting processing LG21, which corresponds to the correcting value calculating section in accordance with the present invention. In the acceleration correcting processing LG21, the acceleration correcting section 6 calculates a sine wave component from the frequency component F obtained in the frequency calculating processing LG20, and carries out the correction by adding the calculated sine wave component to the output of the acceleration sensor 1.

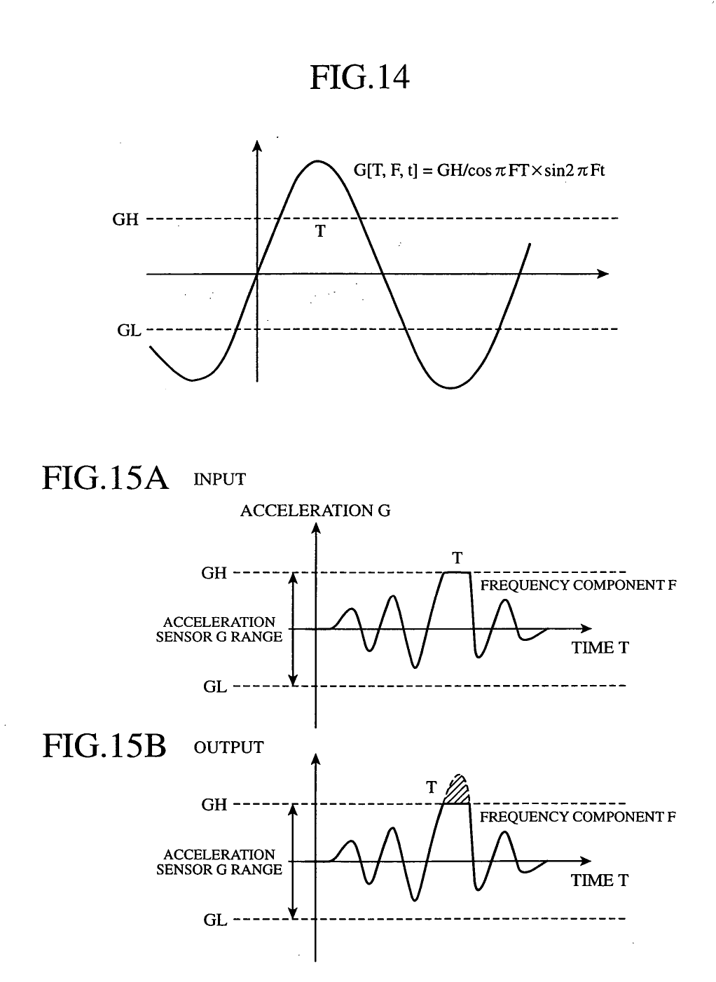

FIG. 14 is a graph illustrating an example of the correcting function used by the acceleration correcting section 6. Assuming that the input waveform is a sine wave, the acceleration correcting section 6 can calculate the waveform from the immediately previous frequency component F and the duration T consisting of the maximum value duration TH or minimum value duration TL according to the following expression (4).
G[T, F, t]=GH/cos πFT×sin 2πFt (4)

The correction based on such a correcting function can correct, when the input G equals the maximum value GH or minimum value GL of the acceleration as illustrated in FIG. 15(A), the input G as illustrated by the shadowed portion in FIG. 15(B).

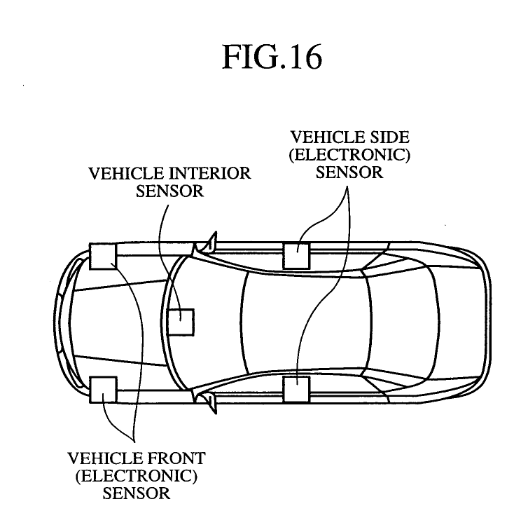

The foregoing embodiments 1-6 of the acceleration detecting apparatus are suitable for configuring the occupant protective system by placing them in the so-called crashable zone in the front of the vehicle as illustrated in FIG. 16, which is likely to be subjected to large acceleration at the crash of the vehicle, as a vehicle front (electronic) sensor. The embodiments 1-6 of the acceleration detecting apparatus are also applicable as an interior sensor of the vehicle by placing one of them at the middle of the vehicle, which undergoes the acceleration smaller than the crashable zone at the crash, and are applicable as the side (electronic) sensors of the vehicle by placing them on the side of the vehicle.

Although the foregoing embodiments 1-4 of the acceleration detecting apparatus are configured such that they calculate the inclination J of the acceleration from the two acceleration values immediately before the maximum value GH or minimum value GL of the acceleration detectable by the acceleration sensor 1, this is not essential. For example, such a configuration is also possible that calculates the inclination J by the least-squares method of two or more acceleration values acquired from the acceleration sensor 1 before the maximum value GH or minimum value GL of the acceleration detectable by the acceleration sensor 1. The configuration can obtain more accurate inclination J.

1. An acceleration detecting apparatus comprising:
an acceleration sensor for detecting acceleration; and
an acceleration correcting section for obtaining, when acceleration outside a range detectable by said acceleration sensor is applied, the acceleration outside the range by calculation.

2. The acceleration detecting apparatus according to claim 1, wherein
said acceleration correcting section comprises:
an inclination calculating section for calculating an inclination of acceleration immediately before one of a maximum value and a minimum value of the acceleration detectable by said acceleration sensor;
a measuring section for measuring duration in which one of the maximum value and minimum value of the acceleration continues; and
a correcting value calculating section for calculating a correcting value from the inclination of the acceleration calculated by said inclination calculating section and from the duration measured by said measuring section, and for performing correction by adding the correcting value to an output of said acceleration sensor.

3. The acceleration detecting apparatus according to claim 2, wherein
said correcting value calculating section calculates the correcting value by multiplying together the inclination of the acceleration calculated by said inclination calculating section, the duration measured by said measuring section, and a specified correcting coefficient.

4. The acceleration detecting apparatus according to claim 1, wherein
said acceleration correcting section comprises:
an inclination calculating section for calculating a first inclination of acceleration and a second inclination of acceleration, the first inclination of acceleration being an inclination of acceleration immediately before one of a maximum value and a minimum value of the acceleration detectable by said acceleration sensor, and the second inclination of acceleration being an inclination of acceleration immediately after passing one of the maximum value and the minimum value of the acceleration;
a measuring section for measuring duration in which one of the maximum value and minimum value of the acceleration continues; and
a correcting value calculating section for calculating a correcting value from the first inclination and the second inclination of acceleration calculated by said inclination calculating section and from the duration measured by said measuring section, and for performing correction by adding the correcting value to the acceleration outside the range detectable by said acceleration sensor.

5. The acceleration detecting apparatus according to claim 1, wherein
said acceleration correcting section comprises:
an inclination calculating section for calculating an inclination of acceleration immediately before one of a maximum value and a minimum value of the acceleration detectable by said acceleration sensor;
a frequency calculating section for calculating a frequency component of the acceleration immediately before one of the maximum value and minimum value of the acceleration detectable by said acceleration sensor; and
a correcting value calculating section for calculating a sine wave component from the inclination of the acceleration calculated by said inclination calculating section and from the frequency component calculated by said frequency calculating section, and for performing correction by adding the sine wave component to an output of said acceleration sensor.

6. The acceleration detecting apparatus according to claims 2, wherein
said inclination calculating section obtains the inclination by a least-squares method from at least two acceleration values acquired from said acceleration sensor before reaching one of the maximum value and minimum value of the acceleration detectable by said acceleration sensor.

7. The acceleration detecting apparatus according to claim 1, wherein
said acceleration correcting section comprises:
a frequency calculating section for calculating a frequency component of the acceleration immediately before one of the maximum value and minimum value of the acceleration detectable by said acceleration sensor;
a measuring section for measuring a time period taken by an acceleration waveform having the frequency component calculated by said frequency calculating section to reach one of the maximum value and minimum value of the acceleration; and
a correcting value calculating section for calculating a sine wave component from the frequency component calculated by said frequency calculating section and from the time period measured by said measuring section, and for performing correction by adding the sine wave component to an output of said acceleration sensor.

8. The acceleration detecting apparatus according to claim 1, further comprising:
a recording section for recording accelerations output from said acceleration sensor during a predetermined time period, wherein
said acceleration correcting section obtains, when acceleration outside a range detectable by said acceleration sensor is applied, the acceleration outside the range by calculation based on the accelerations recorded in said recording section.

9. An occupant protective system comprising:
an occupant protective apparatus installed in a vehicle;
an acceleration sensor for detecting acceleration of the vehicle;
an acceleration correcting section for obtaining, when acceleration outside a range detectable by said acceleration sensor is applied, the acceleration outside the range by calculation; and
a driving unit for driving said occupant protective apparatus in response to the acceleration from said acceleration correcting section.

10. The occupant protective system according to claim 9, wherein said acceleration sensor is placed in a crashable zone of the vehicle.
